(19) United States
(12) Patent Application Publication
(10) Pub. No.: US 2010/0070348 A1
(43) Pub. Date: Mar. 18, 2010

(54) METHOD AND APPARATUS FOR EVALUATION OF BUSINESS PERFORMANCES OF BUSINESS ENTERPRISES

(76) Inventor: Abhijit NAG, Pune (IN)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/623,789

(22) Filed: Nov. 23, 2009

Related U.S. Application Data
(63) Continuation-in-part of application No. 11/059,760, filed on Feb. 17, 2005.

(51) Int. Cl. G06Q 10/00; G06Q 40/00

(52) U.S. Cl. 705/11; 705/347; 705/30

(57) ABSTRACT

The present invention discloses a method and an apparatus for evaluation of business performances of business enterprises. This invention envisages a resource based costing methodology and new form of a company rating designated as resource based profit points or Resource Tool Profit Points [RTPP]. The resources specified here are financial resources and non-financial resources. The financial resources include money (capital), manpower, machines (assets), materials, management, and information; and the non-financial resources include customer focusing, quality of products and services, employee satisfaction and the ability to formulate appropriate business strategies. The RTPP rating computed for a company measures the company's cost strength, value strength and management strength, in a scientific and quantifiable manner. A periodic assessment of companies through the RTP method proposed by the present invention helps in arresting the malignant growth of a company and in highlighting the areas where corrective actions need to be taken.

### RELATED APPLICATIONS

This is a continuation-in-part of patent application Ser. No. 11/059,760 entitled “Method and apparatus for evaluation of business performances of business enterprise” filed Feb. 17, 2005, by Nag Abhijit, which is incorporated by reference in its entirety.

### FIELD OF THE INVENTION

The present invention relates to the field of Performance Evaluation.

Particularly, the present invention relates to a method and an apparatus for evaluation of business performances of business enterprises.

### DEFINITIONS OF TERMS USED IN THE SPECIFICATION

Cost Measure: Cost Measure can be defined as the measure of the performance of a business enterprise in reducing the cost of the final product/service.

Direct Employees: Direct Employees are the total number of the employees which are a part of the pay roll of the business enterprise.

Expenses: Expenses are defined as any costs incurred by a business enterprise which are not derived from material and labour.

Financial Parameters: Financial parameters are parameters like cashflows, liquidity, expenses, capitals which are used for evaluating performance of an enterprise.

Financial Reports: Financial reports are the official records of the financial activities of an enterprise. These records include the balance sheet, statement of cashflow, income statements and the like.

Indirect Employees: Indirect Employees are the total number of employees who are not a part of the pay roll of the business enterprise but are associated with the business enterprise (e.g. consultants, contract workers)

Non-Financial Parameters: Non-financial parameters are parameters like customer focusing, quality of products and services, employee satisfaction, ability to formulate appropriate business strategies which are used for evaluating performance of an enterprise.

Scorecard: Scorecard is an evaluation tool which is in the form of a questionnaire and specifies the criteria that stakeholders use to rate the performance of an enterprise.

Six Sigma Tool (6σ: Six Sigma (6σ) tool is an effective management tool which tactically/strategically changes the focus of businesses from improving the product quality to improving the process quality. If the process deployed is bad, the product it produces cannot be good either.

Spin Rate: Spin rate or Performace rate represents the rate at which a given resource is put to use, or what we may call as ‘resource sharing’.

Value Measure: Value Measure can be defined as the measure of the performance of a business enterprise in offering higher benefits/values to its customers.

Weightages: Weightages are the values or scores assigned to a parameter for its evaluation.

### BACKGROUND OF THE INVENTION

Business performance evaluation has long been attempted in many ways. Some rating systems have attempted to evaluate this only on financial parameters while others have tried to include along with the financial parameters, the non-financial parameters. The Rockwater's Balanced Scorecard is one such apparatus, which permits such evaluation. The Rockwater's balanced scorecard is a strategic performance management tool, the five strategies of the tool include providing services that surpass needs, customer satisfaction, continuous improvement, quality of employees, and shareholder expectations. In addition, the Rockwater's balanced scorecard includes four sets of performance measures covering the Financial perspective, customer perspective, internal business perspective and innovative and learning perspective.

These prior art evaluation devices have mechanisms to record past results to suggest whether a company's performance has been good, or, fair, or, requires improvement. But none of them suggests precisely what needs to be done in the future to change and improve the business performance.

A typical business model consists of an input, which by a process of conversion leads to an output, which is taken to the market. The typical business model is depicted in FIG. 1 of the accompanying drawings. Business basically amounts to identifying market opportunities for a given output product/service, setting up a least cost infrastructure (can be owned/leased) to deliver the same and to run the asset in the most efficient way.

Day to day management of business amounts to running the process of conversion in most efficient manner possible. The process of conversion will be most efficient, when the resources used therein are utilized most efficiently without any waste, so that the cost of the output product/service is the bare minimum and thereby one can afford to aggressively price its products to retain a dominant market position.

### SUMMARY OF THE INVENTION

The present invention envisages a resource based method for evaluating the business performance of a business enterprise, the method comprising the following steps:
allotting weightages to the financial resources of the enterprise consisting of money, material, energy and machines, manpower, management and information, the weightages being further segregated into cost based measures and value based measures, each of these weightages for each of the financial resources ranging in a scale from 3 to 12.5 for cost based measures and from a range of 2.75 to 10.75 for value based measures;
extracting the monetary price from the cost side of the financial report of the enterprise for each of the financial resources in terms of cost, utilization and performance;
computing the total score (A) of the cost based measures which is a summation of the individual scores computed for each of the financial resources based on pre-determined functions using the extracted monetary price, the score being a score in the range of 0 to 400 resource tool profit points;
extracting the monetary value from the sale side of the financial report for each of the financial resources in terms of cost, utilization and performance;
computing the total score (B) of the value based measures which is a summation of the individual scores computed for each of the financial resources based on pre-determined function using the extracted monetary value, the score being the score in the range of 0 to 600 resource tool profit points;
providing a score card for a set of non-financial resources consisting of customer focusing, quality of products and services, employee satisfaction, ability to formulate appropriate business strategies, each of these parameters defined by a set of questions to be responded by designated personnel of the enterprise;
assigning weightages to each of the non-financial resources;
examining the responses elucidated;
computing the score (C) based on the responses and weightages to obtain a score in the scale of 0 to 500 resource tool profit points;
summing the scores of A+B+C to obtain the overall resource based performance of the business enterprise; and
grading the performance from a scale of 0-1500 resource tool profit points in a pre-determined manner.

Preferably, the step of computing the score for the financial resource ‘money’ based on predetermined function using the extracted monetary price includes the following steps:
a) determining a first numerical value by subtracting the value of the risk free rate for money from the numerical value 1 and dividing it by the weighted average cost of capital for money, the first numerical value being multiplied by 5 and further multiplied by a weightage allotted for the sector in which the business enterprise is conducting business;
b) determining a second numerical value by subtracting the value of Capital Employed for money from the numerical value 1 and dividing it by the Cost of Sales for money, the second numerical value being multiplied by 5 and further multiplied by a weightage allotted for the sector in which the business enterprise is conducting business; and
c) summing the first numerical value and the second numerical value.

Preferably, the step of computing the score for the financial resource ‘Material/Energy’ based on predetermined function using the extracted monetary price includes the following steps:
a) determining a third numerical value by subtracting the value of the Material and Energy cost for ‘Material/Energy’ from the numerical value 1 and dividing it by the cost of sales for ‘Material/Energy’, the third numerical value being multiplied by 4 and further multiplied by a weightage allotted for the sector in which the business enterprise is conducting business;
b) determining a fourth numerical value by subtracting the value of Inventory for ‘Material/Energy’ from the numerical value 1 and dividing it by the Cost of Sales for ‘Material/Energy’, the fourth numerical value being multiplied by 6 and further multiplied by a weightage allotted for the sector in which the business enterprise is conducting business; and
c) summing the third numerical value and the fourth numerical value.

Preferably the step of computing the score for the financial resource ‘Machine’ based on predetermined function using the extracted monetary price includes the following steps:
a) determining a fifth numerical value by subtracting the value of depreciation of the ‘Machines’ from the numerical value 1 and dividing it by the cost of sales for ‘Machines’, the fifth numerical value being multiplied by 5 and further multiplied by a weightage allotted for the sector in which the business enterprise is conducting business;
b) determining a sixth numerical value by subtracting the written down value for ‘Machines’ from the numerical value 1 and dividing it by the Cost of Sales for the ‘Machine’, the sixth numerical value being multiplied by 5 and further multiplied by a weightage allotted for the sector in which the business enterprise is conducting business; and
c) summing the fifth numerical value and the sixth numerical value.

Preferably, the step of computing the score for the financial resource ‘Manpower’ based on predetermined function using the extracted monetary price includes the following steps:
a) determining a seventh numerical value by subtracting the value of direct manpower cost for ‘Manpower’ from the numerical value 1 and dividing it by the cost of sales for ‘Manpower’, the seventh numerical value being multiplied by 5 and further multiplied by a weightage allotted for the sector in which the business enterprise is conducting business;
b) determining an eighth numerical value by dividing company average costs of sales by direct employee for ‘Manpower’ and a ninth numerical value obtained by multiplying the industrial average cost of sales by 2 and further dividing the ninth numerical value by the direct employee for ‘Manpower’;
c) determining a tenth numerical value obtained by division of the eighth numerical value by the ninth numerical value, the tenth numerical value being multiplied by 5 and further multiplied by a weightage allotted for the sector in which the business enterprise is conducting business; and
d) summing the seventh numerical value and the tenth numerical value.

Preferably the step of computing the score for the financial resource ‘Management’ based on predetermined function using the extracted monetary price includes the following steps:
a) determining a eleventh numerical value by subtracting the value of indirect manpower for ‘Management’ from the numerical value 1 and dividing it by the cost of sales for ‘Management’, the eleventh numerical value being multiplied by 5 and further multiplied by a weightage allotted for the sector in which the business enterprise is conducting business;
b) determining a twelfth numerical value by dividing company average costs of sales by indirect employee for ‘Management’ and a thirteenth numerical value obtained by multiplying the industrial average cost of sales by 2 and further dividing the thirteenth numerical value by the indirect employee for ‘Management’;
c) determining a fourteenth numerical value obtained by division of the twelfth numerical value by the thirteenth numerical value, the fourteenth numerical value being multiplied by 5 and further multiplied by a weightage allotted for the sector in which the business enterprise is conducting business; and
d) summing the eleventh numerical value and the fourteenth numerical value.

Preferably, the step of computing the score for the financial resource ‘Information’ based on predetermined function using the extracted monetary price includes the step of determining a fifteenth numerical value by subtracting the value of information technology cost for ‘Information’ from the numerical value 1 and dividing it by the cost of sales for ‘Information’, the fifteenth numerical value being multiplied by 10 and further multiplied by a weightage allotted for the sector in which the business enterprise is conducting business.

Preferably, the step of computing the score for the financial resource ‘money’ based on predetermined function using the extracted monetary value includes the following steps:
a) determining a sixteenth numerical value by dividing the economic value addition by the Capital Employed for money by the companies;
b) determining a seventeenth numerical value by dividing the economic value addition by the Capital Employed for money by the industries, the seventeenth numerical is further multiplied by 2;
c) determining a eighteenth numerical value by dividing the sixteenth numerical value by the seventeenth numerical value, the eighteenth numerical value being multiplied by 5 and further multiplied by a weightage allotted for the sector in which the business enterprise is conducting business;
d) determining a nineteenth numerical value by subtracting the value of Capital Employed for money from the numerical value 1 and dividing it by the Cost of Sales for money, the nineteenth numerical value being multiplied by 5 and further multiplied by a weightage allotted for the sector in which the business enterprise is conducting business; and
e) summing the eighteenth numerical value and the nineteenth numerical value.

Preferably, the step of computing the score for the financial resource ‘Material/Energy’ based on predetermined function using the extracted monetary value includes the following steps:
a) determining a twentieth numerical value by adding the expenses to the value of the Material and Energy cost for ‘Material/Energy’ and further subtracting the determined twentieth numerical value from the numerical value 1, and still further dividing the twentieth numerical value by the value of sales for ‘Material/Energy’, the twentieth numerical value being multiplied by 5 and further multiplied by a weightage allotted for the sector in which the business enterprise is conducting business;
b) determining a twenty-first numerical value by subtracting the value of Inventory for ‘Material/Energy’ from the numerical value 1 and dividing it by the value of Sales for ‘Material/Energy’, the twenty-first numerical value being multiplied by 5 and further multiplied by a weightage allotted for the sector in which the business enterprise is conducting business; and
c) summing the twentieth numerical value and the twenty-first numerical value.

Preferably, the step of computing the score for the financial resource ‘Machine’ based on predetermined function using the extracted monetary value includes the following steps:
a) determining a twenty-second numerical value by subtracting the value of depreciation of the ‘Machines’ from the numerical value 1 and dividing it by the value of sales for ‘Machines’, the twenty-second numerical value being multiplied by 5 and further multiplied by a weightage allotted for the sector in which the business enterprise is conducting business;
b) determining a twenty-third numerical value by subtracting the written down value for ‘Machines’ from the numerical value 1 and dividing it by the value of Sales for the ‘Machine’, the twenty-third numerical value being multiplied by 5 and further multiplied by a weightage allotted for the sector in which the business enterprise is conducting business; and
c) summing the twenty-second numerical value and the twenty-third numerical value.

Preferably, the step of computing the score for the financial resource ‘Manpower’ based on predetermined function using the extracted monetary value includes the following steps:
a) determining a twenty-fourth numerical value by subtracting the value of direct manpower cost for ‘Manpower’ from the numerical value 1 and dividing it by the value of sales for ‘Manpower’, the twenty-fourth numerical value being multiplied by 5 and further multiplied by a weightage allotted for the sector in which the business enterprise is conducting business;
b) determining an twenty-fifth numerical value by dividing company average costs of sales by direct employee for ‘Manpower’ and a twenty-sixth numerical value obtained by multiplying the industry average cost of sales by 2 and further dividing the twenty-sixth numerical value by the direct employee for ‘Manpower’;
c) determining a twenty-seventh numerical value obtained by division of the twenty-fifth numerical value by the twenty-sixth numerical value, the twenty-seventh numerical value being multiplied by 5 and further multiplied by a weightage allotted for the sector in which the business enterprise is conducting business; and
d) summing the twenty-fourth numerical value and the twenty-seventh numerical value.

Preferably, the step of computing the score for the financial resource ‘Management’ based on predetermined function using the extracted monetary value includes the following steps:
a) determining a twenty-eighth numerical value by subtracting the value of indirect manpower for ‘Management’ from the numerical value 1 and dividing it by the value of sales for ‘Management’, the twenty-eighth numerical value being multiplied by 5 and further multiplied by a weightage allotted for the sector in which the business enterprise is conducting business;
b) determining a twenty-ninth numerical value by dividing company average costs of sales by indirect employee for ‘Management’ and a thirtieth numerical value obtained by multiplying the industry average cost of sales by 2 and further dividing the thirtieth numerical value by the indirect employee for ‘Management’;
c) determining a thirty-first numerical value obtained by division of the twenty-ninth numerical value by the thirtieth numerical value, the thirty-first numerical value being multiplied by 5 and further multiplied by a weightage allotted for the sector in which the business enterprise is conducting business; and
d) summing the twenty-eighth numerical value and the thirty-first numerical value.

Preferably, the step of computing the score for the financial resource ‘Information’ based on predetermined function using the extracted monetary value includes the step of determining a thirty-second numerical value by subtracting the value of information technology cost for ‘Information’ from the numerical value 1 and dividing it by the value of sales for ‘Information’, the thirty-second numerical value being multiplied by 10 and further multiplied by a weightage allotted for the sector in which the business enterprise is conducting business.

Typically, the method for evaluating the business performance of a business enterprise, allows the weightages to be edited to adapt to dynamic real life situations.

In accordance with the present invention, there is proposed an apparatus for evaluating the business performance of a business enterprise, the apparatus comprising:
a user interface adapted to receive the credentials of a business enterprise and its financial reporting data and feedback in the forms of questionnaires from the stakeholders of the business enterprise;
extraction means to extract the monetary price from the cost side of the financial reports, the monetary value from the sales side of the financial reports and the responses to the questionnaires provided by the stakeholders;
cost measure means (A) co-operating with the extraction means and adapted to evaluate the cost based measure of financial resources including money, material, energy and machines, manpower, management and information, in terms of cost, utilization and performance from the cost side of the financial reports from a scale of 0-400 resource tool profit points based on pre-determined functions;
value measure means (B) co-operating with the extraction means to evaluate the value based measure of financial resources in terms of value, utilization and performance from the sales side of the financial reports from a scale of 0-600 resource tool profit points based on pre-determined functions;
non-financial measure means (C) adapted to evaluate the performance of the business enterprise based on non-financial resources from a scale of 0-500 resource tool profit points based on a set of questionnaires;
summing means to add the scores received from A+B+C; and
grading means to grade the performance from a scale of 0-1500 resource tool profit points in a pre-determined manner.

Typically, the cost measure means is further adapted to assign weightages to each of financial resources ranging in a scale from 3 to 12.5.

Typically, the value measure means is further adapted to assign weightages to each of financial resources ranging in a scale from 2.75 to 10.75.

### BRIEF DESCRIPTION OF THE ACCOMPANYING DRAWINGS

Other aspects of the invention will become apparent by consideration of the accompanying drawings and their description stated below, which is merely illustrative of a preferred embodiment of the invention and does not limit in any way the nature and scope of the invention.

FIG. 1 illustrates a typical business model consisting of an input, which by a process of conversion leads to an output, which is taken to the market;

FIG. 2 is a flowchart showing the steps for evaluating performance of a business enterprise in accordance with this invention;

FIG. 3 is a schematic of the apparatus for evaluating performance of a business enterprise in accordance with this invention;

FIG. 4 illustrates a pictorial view of the equation for calculating element-wise cost build up for costs in the prior art;

FIG. 5 illustrates a pictorial view of the equation for calculating variability-wise cost build up for costs in the prior art; and

FIGS. 6 to 9 are the sample questionnaires for calculating the scores for non-financial resources of a business enterprise in accordance with this invention.

### DETAILED DESCRIPTION

The present invention envisages a method and an apparatus for evaluation of business performances of business enterprises. In particular, this invention relates to a method and apparatus, which in addition to evaluating a given company's performance in the past, also skillfully analyzes the reasons which held them back from not achieving better results, so as to focus appropriately on their future actions for improvement.

This invention envisages a resource based costing methodology for evaluating a business enterprise and providing a new form of a company rating designated as resource based profit points or Resource Tool Profit Points [RTPP]. The resources specified here are financial resources and non-financial resources. The financial resources include money (capital), manpower, machines (assets), materials, management, and information; and the non-financial resources include customer focusing, quality of products and services, employee satisfaction and the ability to formulate appropriate business strategies.

In accordance with one aspect of this invention, the RTP (Resource Tool Profit) rating computed for a company measures the company's cost strength, value strength and management strength, in a scientific and quantifiable manner. A periodic assessment of companies through the RTP method proposed by the present invention will help arrest the malignant growth of a company and highlight the areas where corrective actions need to be taken.

In accordance with another aspect of this invention, the RTP methodology determines how much of the available resources are utilized by an enterprise as the resources constitutes the cost for a given product and/or service. Further, the invention shows the break-up across different resources to illustrate which resources have been used more so that they can be controlled better to achieve more profits.

Furthermore, the method proposed by the present invention is flexible and can be adapted for evaluating the performance of any business enterprise. The method calculates the financial cost and values measures for a business based on the points which differ for different type of businesses for e.g. manufacturing, FMCG (Fast Moving Consumer Goods), Service, Retail, Pharmacy, Apparel and Leisure.

In accordance yet another aspect of this invention, there is provided a method for evaluating the performance of a business enterprise as seen in FIG. 2, the method comprises the following steps:
allotting weightages to the financial resources including money, material, energy and machines, manpower, management and information, the weightages being further segregated into cost based weightages and value based weightages, each of these weightages for each of the financial resources ranging in a scale from 3 to 12.5 for cost based measures and from a range of 2.75 to 10.75 for value based measures, 1000;
extracting the monetary price from the cost side of the financial report for each of the financial resources in terms of cost, utilization and performance, 1002;
computing the score (A) for each of the financial resources based on a pre-determined function using the extracted monetary price, the score being a score in the range of 0 to 400 resource tool profit points, 1004;
extracting the monetary value from the sales side of the financial report for each of the financial resources in terms of cost, utilization and performance, 1006;
computing the score (B) for each of the financial resources based on a pre-determined function using the extracted monetary value, the score being a score in the range of 0 to 600 resource tool profit points, 1008;
providing a score card for evaluating non-financial resources including customer focusing, quality of products and services, employee satisfaction, ability to formulate appropriate business strategies, each of these parameters defined by a set of questions to be responded by designated personnel of the enterprise, 1010;
assigning weightages to each of the non-financial resources, 1012;
examining the responses elucidated, 1014;
computing the score (C) based on the responses and weightages to obtain a score in the scale of 0 to 500 resource tool profit points, 1016;
summing the scores of A+B+C to obtain the overall resource based performance of the business enterprise, 1018; and
grading the performance from a scale of 0-1500 resource tool profit points in a pre-determined manner, 1020.

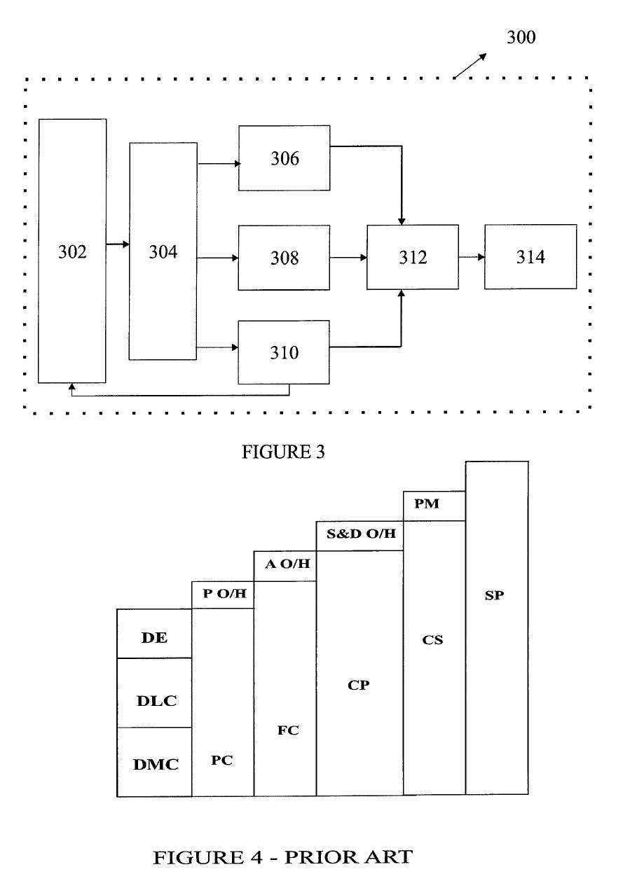

Each of the above steps will now be elaborated to show how the performance evaluation is performed by the apparatus represented by block 300 as seen in FIG. 3 envisaged by the present invention.

The method and apparatus proposed by the invention is proactive in nature i.e. the method and the apparatus accept the current financial records of the business enterprise and based on the RTP calculations direct the enterprises to take corrective actions to make more profits.

The apparatus 300 comprises a user interface 302 which accepts the name of the business enterprise whose performance has to be evaluated and sector of the enterprise from a list of sectors including manufacturing, FMCG (Fast Moving Consumer Goods), Service, Retail, Pharmacy, Apparel and Leisure. In addition, the user interface 302 accepts the financial reports of the business enterprise including the profit and loss statement and the balance sheet and the questionnaires filled by the stakeholders. Based on the financial reports the financial resource cost and utilization (cost measures and the value measures) are calculated.

These financial inputs are given to the extraction means 304 which extracts the monetary price from the cost side of the financial reports, the monetary value from the sale side of the financial reports and the responses to the questionnaires provided by the stakeholders and provides these extracted values to the cost measure means 306, value measure means 308 and the non-financial measure means 310.

The cost measure means 306 receives the extracted monetary price from the cost side of the financial reports and calculates the cost of the financial resources based on the cost and utilization of the individual financial resources like Money, Material, Machine, Manpower, Management, and Information.

| | | | | % TC | | |
|---|---|---|---|---|---|---|
| | | | | (Total | Effective | Functional |
| | Idling | Spin Rate | Cost | Cost) | Impact | Management |
| Resource | (1) | (2) | (3) | (4) | (5) = 2 × 4 | Tools |
| Money (M₁) | Yes/No | $\frac{{dM}_{1}}{dt} ( 1 - {W}_{1} )$ | | | | TM, FM |
| Material and Energy (M₂) | Yes/No | $\frac{{dM}_{2}}{dt} ( 1 - {W}_{2} )$ | | | | SCM, 6σ, SPC |
| Machine (M₃) | Yes/No | $\frac{{dM}_{3}}{dt} = OEE ( 1 - {W}_{3} )$ | | | | TPM, MRPII, IE |
| Manpower (M₄) | Yes/No | $\frac{{dM}_{4}}{dt} ( 1 - {W}_{4} )$ | | | | IE, HR, ESI |
| Management (M₅) | Yes/No | $\frac{{dM}_{5}}{dt} ( 1 - {W}_{5} )$ | | | | Benchmarking, TQM |
| Information (M₆) | Yes/No | $\frac{{dM}_{6}}{dt} ( 1 - {W}_{6} )$ | | | | ERP, WAN, EDE |

TABLE 1 shows the resources which are used in the process of conversion in a business.

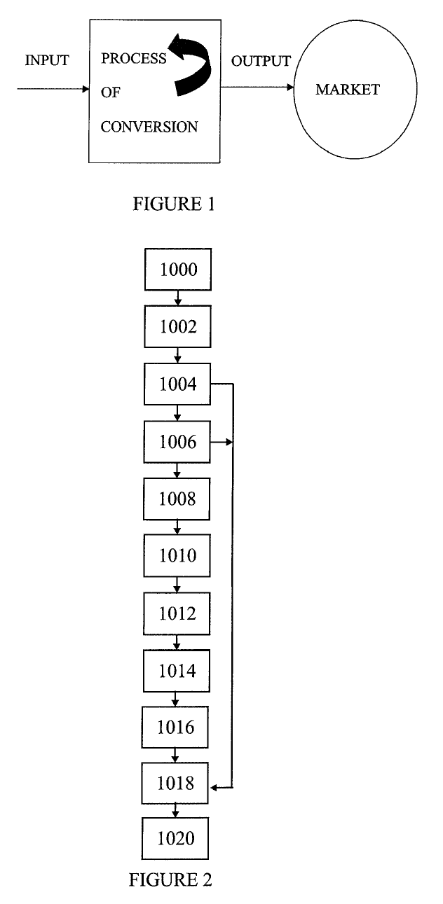

As seen in the FIG. 1, the process of conversion for a business will be most efficient when the resources used therein are utilized most efficiently without any waste. The resources, which are used in the process of conversion, are (5 Ms+IT) as shown in TABLE 1.

In the TABLE 1, W=Weightage of rejects/process loss and OEE=Operating Equipment Efficiency.

The following statement therefore can represent a typical business model: The product interfacing process interfaces with another product which strikes the market. In order to make the business process most efficient, one has to ensure that none of the resources which are pumped in the process, which cost the company dearly, are allowed to idle (wasted), or, allowed to produce products or, allowed to get spoilt during a production process as rejects/rework. Therefore, business management at the generation/manufacturing stage literally boils down to efficient resource management. The more vigorous is the resource management activity, the most cost competitiveness the company achieves, with a given ‘product-process-market’ configuration.

TABLE 1 also illustrates the Functional Management Tools, which need to be used for improving the respective resource utilization, thereby increasing the efficiency of the process of conversion.

In TABLE 1 the following reference terms have the meaning mentioned alongside.

### TM=Treasury Management ESI=Employees Satisfaction Index

### FM=Financial Management EDE=Electronic Data Exchange

### 6σ=Six Sigma TPM=Total Productive Maintenance

### IE=Industrial Engineering TQM=Total Quality Management.

### WAN=Wide Area Networking ERP=Enterprise Resource Planning

### SCM=Supply Chain Management

MRRII=Manufacturing Resource planning II.

### Benchmarking=Benchmarking Management Tool.

For example, in order to improve the efficiency of the first type of resource, ‘MONEY’, the Functional Management Tools (FMTs) that should be used are Treasury Management, and Financial Management. They will work as follows:

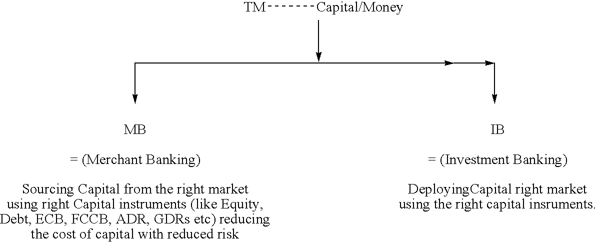

The TM-tools must ensure least cost of capital and most profitable deployment of idle capital (Money). FM-tools must ensure highest use/efficiency of working capital.

Similarly, for other types of resources, in order to improve the non-idleness and to increase their spin rate, FMTs must be used as mentioned in the last column of TABLE 1.

The different variables in TABLE 1 can be explained as follows:

### (M₁) Money:

As a first step, Money/Capital must not be allowed to be idle—Money is referred in terms of the capital which has been used to raise the business and then to run it (fixed capital+working capital). If as an individual, one has US $100,000, in currency and has kept it in the security of a safe in the bedroom, everyday before he/she goes to bed at night, he/she opens the safe to ensure that the money is safe and not stolen. The individual gets into a habit and he/she does not get a sound night's sleep, unless the bedroom safe is opened every night and he sees that the money is parked there safely.

Over a period of 3 years, though one has ensured the custodial safety of the money, but as the money has been kept idle, its economic value has been eroded by a whopping 15% (assuming annual average inflation rate of 5%). On the contrary, if you one had rolled the money in some productive investment and he/she would have earned a return on investment of at least 10%, then the differential increase in the resource (money) utilization would have been 15% (5%+10%). While the loss is perceptible for allowing money, as a resource, to idle in the case of an individual, the same holds true for a business enterprise as well.

Therefore, no business enterprise should allow money to idle. Money should be raised at the least cost (WACC=weighted average cost of capital) through judicious and scientific merchant banking management/scientific capital structuring and utilized to the maximum. If there is surplus money from operations, or, other sources, they must not be allowed to idle (by parking it up in the current account of the company).

Money should be judiciously and scientifically put to use through ‘investment banking management’, so that profit generated from this operation can compliment that from the normal business operation of the company. This forms ‘other income’ besides revenue from sales. An efficient merchant banking operation combined with an efficient investment banking operation for a company makes its treasury operation very efficient, which ensures non-idleness and highest spin rate of money, as a resource base.

### (M₂) Material+Energy:

Like money as a resource base, material as a resource base must not be allowed to idle. For a products' company, material cost constitutes the highest resource-cost component. While manpower-cost for such companies should be attempted to be held within 10% of Total Cost (=TC), their material cost can be at times as high as 50% of the Total Cost (=TC). Such high cost resource should not be allowed to idle. Idling of material manifests itself as ‘inventory’. Thus the total inventory carried by a company can be represented as follows:

$$Total Inventory Of a company ( I ) = Raw Material Inventory ( R M I ) + Work In Process Inventory ( W I P I ) + Finished Goods ( F G I ) \\ I = R M I + W I P I + F G I$$

Raw materials inventory represents idling of raw materials i.e. raw materials waiting and hence idling, waiting to be taken up for the process of conversion. Similarly, work-in-progress inventory represent idling of materials, wherein part of the operations have been completed and waiting to be taken up for the balance operations and the finished-goods inventory represents idling of materials where all the operations have been completed and waiting to be sold to the customers/consumers. All these idling/waiting materials do not add any value to the materials (except in wine manufacturing) and only increase the cost and therefore, must be ruthlessly avoided by a business enterprise.

Just-in-time (JIT) is an inventory strategy that strives to improve a business's return on investment by reducing in-process inventory and associated carrying costs. To meet JIT objectives, processes rely on signals between different points, which tell production when to make the next part. Kanban are usually ‘tickets’ but can be simple visual signals, such as the presence or absence of a part on a shelf. One must, therefore, attempt to drive a business inventory-less so as to effectively bring in Kanban and JIT in operations.

The spin rate of materials as a resource must be targeted to increase by:
a. Reducing the process waste/rework [(I-w) is the effective output weight, ‘w’ being the process waste]. Yield should go up;
b. Reducing the throughput time of the conversion process [which includes producing the output product quickly and pushing it expeditiously through the outbound logistics system till it hits the ultimate consumer on the extreme end position]; and
c. Material cost should go down by better sourcing (effective BPO).

Thus, material as a resource base, is the highest cost contributor, and must achieve the following objectives at a progressively higher level:
a. Inventory should come down;
b. Supply-chain throughput time should come down;
c. Process yield should up; and
d. Material cost should go down.

When the above results take place, column (5) in TABLE 1 (Resources-based costing), material as a resource cost will have the least impact on the end product, making the product-cost most competitive.

(M₃) Machine: The machine, the manufacturing plant (for products-company) and the appropriate infrastructure (in other forms of business) must not be allowed to idle. Idling of infrastructure makes the process of conversion inefficient, and the end-product cost less competitive.

Thus, if a new machine line for a new product of the company has to be set up, checks for the uptime of the machines must be performed periodically. If the uptime (or, utilization) is lesser than targeted (˜100%), analysis of the causes of downtime, viz., operators being absent, not being trained, inadequate tooling, jigs and fixtures not being fool-proof, loading and unloading of jobs being time consuming, materials not being available, market order not available and the like must be considered and immediate appropriate measures must be taken to plug the losses and increase the machine/infrastructure utilization. The reasons for lower plant/infrastructure capacity utilization can be because of reasons related to manufacturing, or, reasons related to marketing (lack of adequate orders), or, both. All of them have to be expeditiously addressed in order to make the process of conversion efficient, to be able to sustain the business.

In house reasons should be addressed to increase OEE (Operating Equipment Efficiency) by use of TPM (Technical Performance Measure), ERP (Enterprise Resource Planning) application for M-M (Manufacturing and Material) module including PPC (Production Planning and Control) and the like while the market-based reasons should be handled through effective selling and marketing, export market and even by undertaking contract manufacturing wherever found feasible.

Higher and higher infrastructure utilization must be attempted through application of Kaizen/Continuous Improvement Programme, being undertaken taking the involvement of all the employees of the enterprise. Kaizen typically refers to activities that continually improve all functions of a business, from manufacturing to management and from the CEO to the assembly line workers. Kaizen works by improving the standardized business activities and processes, and aims to eliminate waste/lean manufacturing. The five main element of Kaizen include Teamwork, Personal discipline, improved morale, quality circles and suggestions for improvement. The effective improvement by the use of this resource base will help the company to:
a) Increase the throughput volume of the conversion process;
b) reduce the running cost/expenses/energy/consumption of the infrastructure/plant; and
c) reduce TCO (Total cost of ownership=acquisition cost+running cost) of the plant/machinery/infrastructure.

The result of all the above steps will be to make the least impact of column (5) in TABLE 1 (Resource-based costing) of machine/infrastructure as a resource cost on the end product, making the product-cost most competitive in the market, with a given product-process-market configuration.

### (M₄) Manpower Resource:

Like other resources, manpower as a resource base cannot be allowed to idle. Manpower represents the most strategically important resource, which if properly harnessed can take an organization to great heights of achievement, and if not, can ruin the organization to a level of closure. For a typical products company, in terms of a pure cost item, manpower cost should not exceed 10% of the total cost. If a company's average labor efficiency is just 70%, wherein the products achieve a near monopoly in the market retaining a profit margin of 40%, then the company must decide not to push hard to increase the manpower efficiency by 25% to bring it to an acceptable level of 95%, facing, or, antagonizing, or, convincing the labor unions and workmen because it increases the profit margins by just 2.5% (as labor, or, manpower cost represents for your company 10% of the total cost). But strategically this will amount to a wrong management move, throwing a wrong signal of acceptance of inefficiency of manpower. Thus today's 70% may spiral down to 65%, to 60% and then to 50% and so on. Manpower controls the other resource bases also, and employees might think that if a company has allowed their inefficiencies, they might as well allow inefficiencies of other resource utilization also. This will turn, in no time, an otherwise healthy 40% profit margin to a loss, or a negative margin. Therefore, manpower as a resource, for some companies, may not be very important from a cost point of view, but of immense importance from the company's strategic point of view. The company must not allow the ‘work culture’ to be eroded; as it takes years of hard toil to bring back a good and, efficient work culture.

Therefore, one must ask more from the manpower. If they are giving 40 units per shift today, one must ask for 50 units; when they achieve 50 units, congratulate them and then ask for 60 units. Keep increasing the benchmark, and as manpower has an infinite capacity to respond to the ever-increasing demand. In the process, one is not giving injustice to them, in fact, providing the best justice to them. Manpower is prepared to produce better and better results, working closer and closer to their potential. This will increase their skill; develop their intellect, and their ability to do hard work, thereby increasing their market worth and marketability. The worst form of punishment, which can be inflicted on a human being, is to deny him/her any work. If any manpower is not provided work for three or more years, then he/she will be no better then a log of wood, a complete vegetable, capable of doing nothing. Therefore, to make a human bring out the most of him/her, the only way is to load him/her with more and more work/task. Human beings can, therefore, be compared to diamonds. The more you polish them, the more shine you get out of them. Similarly, manpower as a resource base, strategically the most important resource, must be utilized to their best potential, always encouraged to scale higher and higher peaks of achievement. This will make the impacted cost in column (5) of TABLE 1 (Resource-Based Costing) on the end product the least, making the product-cost most competitive.

### (M₅) Management:

A company/business enterprise may have all the above 4 resources, but a bad management may whittle away all the resources and not take advantage of the synergistic benefits. Therefore, management as a resources base is the most critical one—as they have the capacity to make it, or, break it. Their vision for the company, selecting the most appropriate product-process-market configuration, sourcing the product(s)-delivery infrastructure economically and running the infrastructure most efficiently makes the company's operations most profitable and thereby, ensuring Economic Value Addition (EVA) in a continuous, and ever-sustaining way.

### (M₆) Information:

Generating information, transmitting the decision-making process, making the two-way communication, help the organizations run their operations more efficiently and transparently. Management decision-making must be more and more data and information-driven, quantitative, transparent and objective, rather than being subjective based on hunches, intuitions, gut-feelings and here-says. Information provides forward visibility and makes the operations highly efficient. If the visibility is not clear, the company tends to become defensive and tend to hedge its future by carrying higher inventory of products in the supply-chain-pipeline making the operations lesser efficient. More and more use of information will make the organization work on a real-time basis increasing the efficiency significantly. Therefore, information is a very important resource base, and must achieve the following objectives:
a. Company-wide computerization as a first step and then computerization across the supply-chain.
b. On-line connectivity within a lead-firm operation through integrated ERP implementation.
c. Wide area networking across operating platforms and supply-chain partners.

### Cost Calculation:

Costing of a product has been done till today by two methodologies:

(i) Element-wise cost build-up
(ii) Variability-wise cost build-up

### I. Element-Wise Cost Build-Up:

Here product cost is built-up from material cost, labor cost and expenses, each of which is broken into ‘direct’ and ‘indirect’

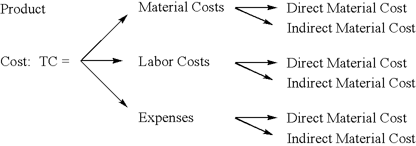

Direct materials are those materials, which are directly identifiable or, visible in the end product, and their costs are not of insignificant proportions like steel items of an automobile, or, cloth used for making garments in a garment industry etc. Costs of such direct materials are direct material costs. Materials, which are not directly identifiable, or, visible with the end product, or, though visible but not of insignificant proportions, or, values, are called indirect materials. For example, button and threads in the garments though visible in the end product are treated as indirect materials, due to their insignificant proportions in the total cost of the product.

Similarly, direct labor are those manpower who are directly engaged in the productions of end products of the company, like operators working on the machines for production of component parts and assembly of finished goods of the company. All other manpower engaged in providing support services to this direct production activity, like people working in the maintenance department, accounts department, HR department and the like are indirect workmen. Costs of direct labor are called direct labor cost, which includes their salaries and wages and other indirect benefits given to them. Similarly, costs associates with indirect labor are called indirect labor cost.

In the same way, expenses, which are directly identifiable with the production of finished goods of the company, like electricity consumption of the production shops of the company, are called direct expenses and all other expenses are termed as indirect expenses. The summary of total cost (TC) of the product can be written as follows:

$$\begin{matrix}TC = MC + LC + E \\ = ( DMC + IMC ) + ( DLC + ILC ) + ( DE + IDE ) \\ = ( DMC + DLC + DE ) + ( IMC + ILC + IDE )\end{matrix} \\ TC = Prime Cost + Overheads Costs \qquad ( 1 )$$

### Where:

MC=Material Cost. E=Expenses.
DMC=Direct Material Cost. SP=Sales Price.
TC=Total Cost of the product. CS=Cost of Sales.
LC=Labor Cost. CP=Cost of Production.
DLC=Direct Labor Cost. FC=Factory Cost.
IDMC=Indirect Material Cost. PC=Prime Cost.
IDLC=Indirect Labor Cost. IDE=Indirect Expenses.

### DE=Direct Expenses.

Now, Overhead Costs can be broken into three parts, depending on where the overhead expenses have been spent like:

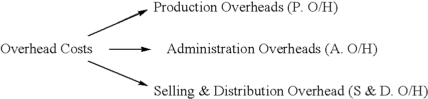

Thus, equation number (1) can be rewritten as:

$$T C = P C + P O / H + A O / H + S \& D O / H \qquad ( 2 )$$

This equation is pictorially represented in FIG. 4 of the accompanying drawings. Element wise cost build-up, or, break-up in the reverse order, is done by the above methodology.

### II. Variability-Wise Cost Build-Up:

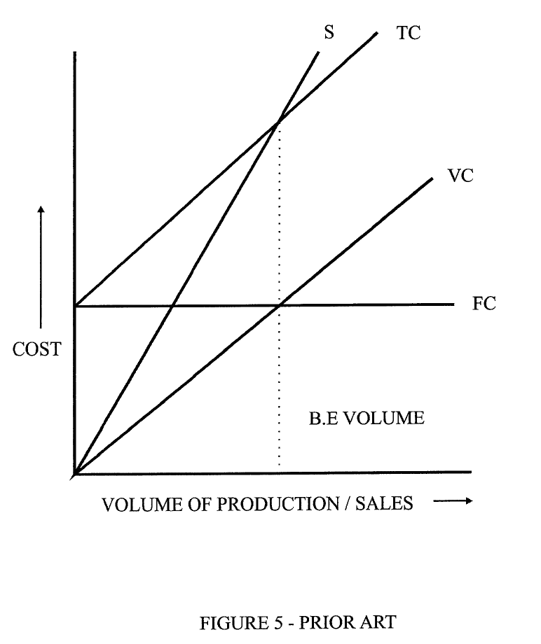

Here the total cost of the product is broken into/built-up from two components-fixed cost and variable cost. This methodology is also called marginal costing technique, or, Cost-Volume-Profit analysis. CVP analysis or, Marginal Costing technique is graphically depicted in FIG. 5 of the accompanying drawing:

Referring to FIG. 5 of the drawing the following equation can therefore be deduced:

$$T C = F C + V C \qquad ( 3 )$$

### Where:

TC=Total Cost of the product.

### FC=Fixed Cost.

### VC=Variable Cost.

### S=Sales.

This methodology of finding the total cost, also called Break-even (B.E) analysis, is variability wise build-up of total cost of a product.

In accordance with this invention, the cost measure means 306 uses a third alternative method of product cost build up based on the six resources used to produce the product. This resource-based costing methodology has been used to find the efficiency, or, rating of business enterprises. Therefore, 6 Ms in the TABLE 2 shows a cost-based measurement index, graded on 400 RTP points.

| | Cost Measures | | | | | | | | |
|---|---|---|---|---|---|---|---|---|---|
| | | Rate of | | | | | | | |
| | | Use/ | Points based on sectors | | | | | | |
| Output | Cost | Turnover | MFG | FMCG | SERVICES | RETAIL | PHARMA | APPAREL | LEISURE |
| Money | 1 − Risk Free | 1 − CE/ | 6 | 5 | 5 | 10 | 6 | 5 | 3 |
| (M₁) | Rate/WACC × 5 | Cost of Sales × 5 | | | | | | | |
| Material/ | 1 − Material + | 1 − Inventory/ | 10 | 8 | 3 | 12.5 | 6 | 6 | 4 |
| Energy | Energy Cost/ | Cost of Sales × 6 | | | | | | | |
| (M₂) | Cost of Sale × 4 | | | | | | | | |
| Machine | 1 − | 1 − WDV/ | 6 | 4 | 3 | 3 | 6 | 6 | 3 |
| (M₃) | Depreciation/ | Cost of Sales × 5 | | | | | | | |
| | Cost of Sales × 5 | | | | | | | | |
| Manpower | 1 − Direct | (Company | 8 | 6 | 12.5 | 5 | 10 | 5 | 10 |
| (M₄) | Manpower | Avg. | | | | | | | |
| | Cost/ | Cost of | | | | | | | |
| | Cost of sales × 5 | Sales/ | | | | | | | |
| | | Direct | | | | | | | |
| | | Employee)/ | | | | | | | |
| | | (2 × Industry | | | | | | | |
| | | Avg. | | | | | | | |
| | | Cost of | | | | | | | |
| | | Sales/ | | | | | | | |
| | | Direct | | | | | | | |
| | | employee) × 5 | | | | | | | |
| MGT | 1 − Indirect | (Company | 6 | 10 | 12.5 | 5 | 10 | 10 | 10 |
| (M₅) | Manpower/ | Avg. | | | | | | | |
| | Cost of | Cost of | | | | | | | |
| | Cost of Sales × 5 | Sales/ | | | | | | | |
| | | Indirect | | | | | | | |
| | | Employee)/ | | | | | | | |
| | | (2 × Industry | | | | | | | |
| | | Avg. | | | | | | | |
| | | Cost of Sales/ | | | | | | | |
| | | Indirect | | | | | | | |
| | | Employee) × 5 | | | | | | | |
| Information | 1 − IT Cost/ | — | 4 | 7 | 4 | 4.5 | 8 | 9 | 10 |
| (M₆) | Cost of Sales × | | | | | | | | |
| | 10 | | | | | | | | |
| | | | 400 | 400 | 400 | 400 | 400 | 400 | 400 |

TABLE 2 shows the functions used for calculating the cost measures for financial resources of a business enterprise

where,
WACC=weighted average cost of capital.

### CE=Capital Employed

### WDV=Written Down Value of the Machine/Asset

The cost of each resource is calculated based on the cost and utilization of the resource for instance, cost of Machine is calculated as:

(1−Depreciation/Cost of Sales)×5×(no of points depending on the sector)and a)

the utilization of the machine is calculated as:

(1−WDV/Cost of Sales)×5×(no of points depending on the sector) b)

(a)+(b) gives the total cost of the resource. Similarly, based on the functions of cost and utilization as defined in TABLE 2 the cost of the individual financial resources is calculated.

To be able to achieve the business goals only the cost of resources going down is not sufficient, the value of the resources must also increase. Value can be defined as the money customers are willing to pay for a company's products. The challenge therefore that many companies face is how to value drive the products i.e. for instance how to make a $2 product appear $6 worth in the eyes of the customers. The present invention calculates the value measures for each of the identified financial resources using the value measure means 308. The value measure means 308 calculates the value measure of each of the resources on a value-based measurement index, graded on 600 RTP points as seen in TABLE 3. The value measure means 308 calculates the value of the products by summing the value and the utilization calculated for each of the individual resources by accepting the monetary value from the sales side of the financial reports from the extraction means 304.

| | Value Measures | | | | | | | | |
|---|---|---|---|---|---|---|---|---|---|
| | | Rate of | | | | | | | |
| | | Value/ | Points based on sectors | | | | | | |
| Output | Value | Turnover | MFG | FMCG | SERVICES | RETAIL | PHARMA | APPAREL | LEISURE |
| Money | (EVA/CE)_{co}/ | 1 − CE/ | 9 | 7.5 | 7.5 | 15 | 9 | 7.5 | 4.5 |
| (M₁) | 2 × | Cost of | | | | | | | |
| | (EVA/ | Sales × 5 | | | | | | | |
| | CE)_{IND}, × 5 | | | | | | | | |
| Material/ | 1 − Material | 1 − | 15 | 12 | 4.5 | 18.75 | 9 | 9 | 6 |
| Energy | and | Inventory/ | | | | | | | |
| (M₂) | Energy Cost + | Sales × 5 | | | | | | | |
| | E/Sale × 5 | | | | | | | | |
| Machine | 1 − | 1 − WDV/ | 9 | 6 | 4.5 | 4.5 | 9 | 9 | 4.5 |
| (M₃) | Depreciation/ | Sales × 5 | | | | | | | |
| | Sales × 5 | | | | | | | | |
| Manpower | 1 − Direct | (Co Avg. | 12 | 9 | 18.75 | 7.5 | 15 | 7.5 | 15 |
| (M₄) | Manpower | Cost of | | | | | | | |
| | Cost/ | Sales/ | | | | | | | |
| | sales × 5 | Direct | | | | | | | |
| | | Employee)/ | | | | | | | |
| | | (2 × | | | | | | | |
| | | Industry | | | | | | | |
| | | Avg. | | | | | | | |
| | | Sales/ | | | | | | | |
| | | Direct | | | | | | | |
| | | employee) × 5 | | | | | | | |
| MGT | 1 − Indirect | (Company | 9 | 15 | 18.75 | 7.5 | 15 | 15 | 15 |
| (M₅) | Manpower | Avg. | | | | | | | |
| | Cost/ | Cost of | | | | | | | |
| | Sales × 5 | Sales/ | | | | | | | |
| | | Indirect | | | | | | | |
| | | Employee)/ | | | | | | | |
| | | (2 × | | | | | | | |
| | | Industry | | | | | | | |
| | | Avg. | | | | | | | |
| | | Sales/ | | | | | | | |
| | | Indirect | | | | | | | |
| | | Employee) × 5 | | | | | | | |
| Information | 1 − IT Cost/ | — | 6 | 10.5 | 6 | 2.75 | 12 | 13.5 | 15 |
| (M₆) | Sales × | | | | | | | | |
| | 10 | | | | | | | | |
| | | | 600 | 600 | 600 | 600 | 600 | 600 | 600 |

TABLE 3 shows the value measures for financial resources of a business enterprise.

For instance, the value of Material/Energy is calculated as the value of the material/energy given by:

(1−Material Cost+E)/Sales×5×(no of points depending on the sector) a)

and
the utilization of the resource is calculated as:

1−C/Sales×5×(no of points depending on the sector) b)

Thus, the total value of the financial resource Material/Energy is calculated as (a)+(b).

In TABLE 3, EVA stands for economic value addition.

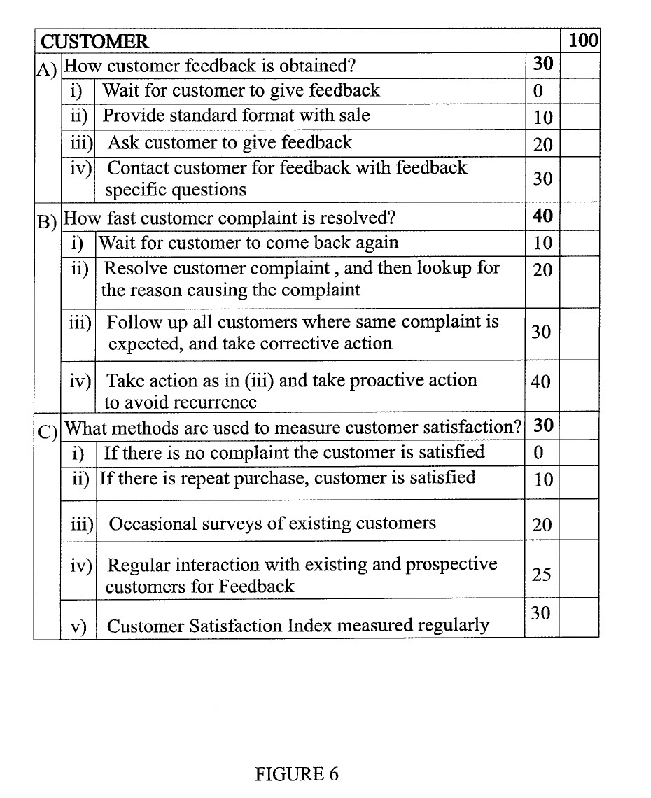

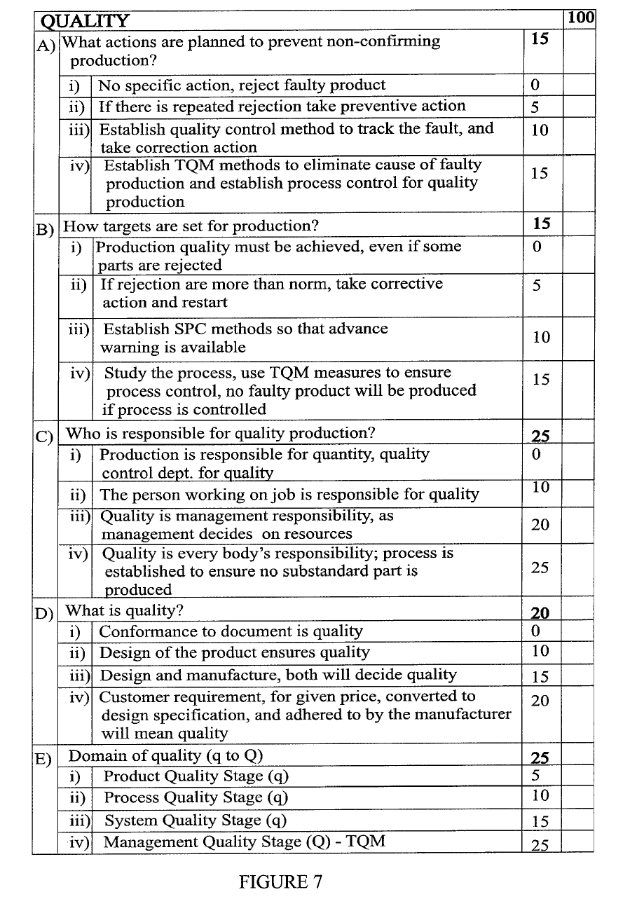

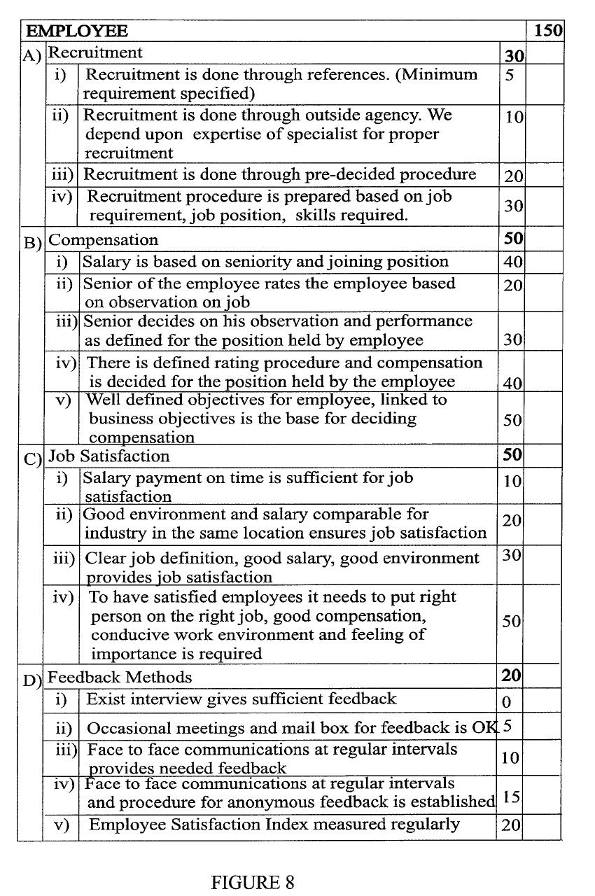

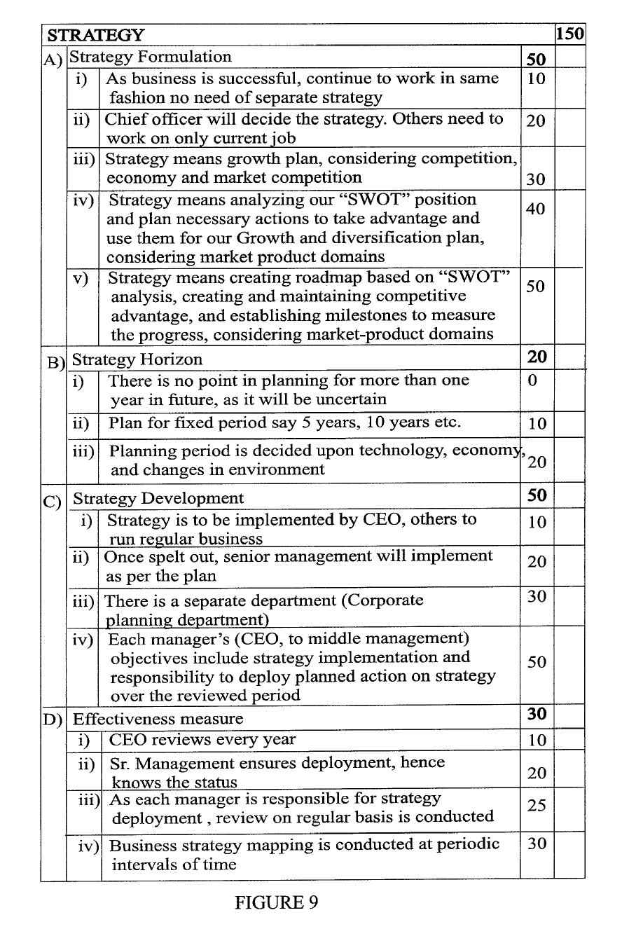

Along with the financial value and cost measures, this invention, also takes into account non-financial resources. The non-financial performance measures are evaluated by non-financial measure means 310. The non-financial measure means incorporates a repository consisting of a set of questionnaire prepared on four important business parameters—Quality, Employees, Customers and Strategy-representing pro-active nature of the management. Each of the questions in the questionnaire is assigned a score/weightage. The questionnaire and weightage RTP points are liable to be changed, as and when deemed necessary depending on experience and expediency of the cases. The questionnaire forming part of the apparatus and method of this invention is shown in FIGS. 6 to 9 of the accompanying drawing.

The questionnaires are provided to the user interface 302 and these are to be filled by stakeholders like the customers and employees. The responses to these questionnaires are collected by the extraction means 304 and on basis of the response and the pre-assigned weightages to the questions of the questionnaire the score for the non-financial resources is computed by the non-financial measure means 310, the score is typically in the range of 0-500 RTPP.

In accordance with the invention once all the financial and non-financial measures are computed, the summing means 312 sums up the totals together to get a scorecard having a maximum of 1500 RTP points for a business enterprise.

Thus, a company's performance is tracked on the basis of a score computed for
cost measures which is in the range of 0-400 RTPP;
value measures which is in the range of 0-600 RTPP; and
non-financial performance measures which is in the range of 0-500 RTPP.

The shortcomings are identified, analyzed and short-term and long-term action plans are suggested for implementation by the company. The implementations programmed are also tracked to record improvement. Different weightages are given for different types of business, taking into consideration the unique features of each domain of business and industry. The weightage RTP points may be altered depending on experience and expediency of each case.

The business rating is not a passive tool but an active and dynamic tool of application to strategically turn around a company towards dramatic and guaranteed improvement.

This resource-based costing methodology has been used to find the efficiency, or, rating of business enterprises. Therefore, 6 Ms have a cost-based measurement index, graded on 400 RTP points and also a value-based measurement index, graded on 600 RTP points. Besides non-financial performance measures have been a measurement index of 500 RTP points, all adding up together to a scorecard of a maximum of 1500 RTP points.

The grading means 314 receives the total RTP points achieved by an enterprise and further grades the enterprise/company based on the ranges of the RTP points as seen in TABLE 4.

| RTPP Score | Grade/Rating |
|---|---|
| 1300 to 1500 RTP points | PPPP |
| 1100 to 1300 RTP points | PPP |
| 800 to 1100 RTP points | PP |
| 600 to 800 RTP points | P |
| <600 RTP points | -P |

TABLE 4 shows the score computed and the corresponding grades

As seen in TABLE 4 ‘PPPP’ is the best grade which can be given to a business enterprise on its performance and the −P being the poor grade.

The invention will now be described with respect to the accompanying examples:

### Example 1

A) Sector: Manufacturing

B) Name of the Company: ABC Co. Ltd., engaged in manufacturing of automobiles

C) Business Operations: The company is engaged in manufacturing different types of automobiles, starting with manufacturing different types of automobiles, starting with Heavy Commercial Vehicle (I-ICV), commercial Vehicle (Cr). Light Commercial Vehicle (LCV), Multi Utility Vehicle (MIJV), Sports Utility Vehicle (Suv) and Passenger cars of B and C-Segment. The company has 4 large plants scattered around different corners of a country. Recently the company has bought an overseas company manufacturing automobiles. The company has its own R & D center, designing its own vehicles. The company initially had a technical collaboration with a well-known multinational of automobile manufacturing; the technical collaboration now does not exist and the company has over the years developed its own design capabilities. For the last many years, all the vehicles launched by the company in the market have been designed and prototyped, and productions and have met with substantial success in the local country market. Expert efforts to the developing countries of other continents have also borne reasonable success.

### Example III

A) Business

Sector: Service

B) Name of the Company: CS Ltd.

C) Business Operations In a world where listening to customers is merely a basic requirement for success, the company has gone several steps ahead in customizing every function within the organization, be it people, process, technology, or, solution delivery, to focus or delivering what customers' business demands. Perhaps, it is this leadership trait that has won the company an available list of over 300 global customers, including more than 100 Fortune Global 500 companies. The company is an information technology (IT) services provider that uses a global infrastructure to deliver value-added services to its customers, to address IT needs in specific industries and to facilitate electronic business, or, e-Business, initiatives. The Company has offshore development centers located throughout India that enables it to provide high quality and cost-effective solutions to clients. It also has offsite centers located in the United States, United Kingdom, Germany, Singapore, Malaysia, Australia, Japan and Dubai. The range of services offered by it, either on a “time and material” basis, or, “fixed price”, includes consulting, systems design, software development, system integration and application maintenance.

The Company offers a comprehensive rang of IT services, including software development, packaged software integration system maintenance and engineering design services. The Company has established a diversified base of corporate customers in a wide range of industries including insurance, banking and financial services, manufacturing, telecommunications, transportation and engineering services. During the financial year 2003-04, the company recorded total revenues of US$576.54 million, comprising income from software services of US$558.58 million, other income of US$17.96 millions, and a net profit of US$122.15 millions. North America, Japan, Europe and the rest of the world contributed 73.34%, 1.97%, 13.7 1% and 10.98% respectively, to the total revenues. The offshore share of the revenues during the year was 42.7%, while the onsite share was 57.3%.

### TECHNICAL ADVANTAGES

The technical advantages of the present invention include in providing a method and an apparatus which are uniquely designed based on a costing technology which measure the business performance in an integrated, quantifiable and objective way so that the business can be skillfully analyzed and the reasons which held them back from not achieving better results can be determined, so the companies can focus appropriately on their future actions for improvement.

The invention takes into consideration three parameters for evaluation of a businesses performance. The three parameters include the cost measure of the financial resources, the value measure of the financial resources and the measure of the non-financial resource. The financial resources which are evaluated include Money, Material/Energy, Machine, Manpower, Management and Information. The non-financial resources include customer focusing, quality of products and services, employee satisfaction, and the ability to formulate appropriate business strategies.

The invention assigns weightages to each of the three parameters and then sums the scores calculated for each of the three parameters (i.e. cost measure, value measure, non-financial resource measure) to achieve a resource based RTP rating and subsequent grade for the company/enterprise.

Each of the three parameters is rated based on RTP points. The parameter ‘cost measure of the financial resources’ is rated based on 400 points, the parameter ‘value measure of the financial resources’ is rated based on 600 points and the parameter ‘measure of the non-financial resources’ is rated based on 500 points. Thus, if a company receives a low score for any of the individual parameters they will know which area of the company needs more focus and in addition the invention also mentions the functional management tools which will be needed to improve the performance in that parameter.

While considerable emphasis has been placed herein on the particular features of this invention, it will be appreciated that various modifications can be made, and that many changes can be made in the preferred embodiments without departing from the principles of the invention. These and other modifications in the nature of the invention or the preferred embodiments will be apparent to those skilled in the art from the disclosure herein, whereby it is to be distinctly understood that the foregoing descriptive matter is to be interpreted merely as illustrative of the invention and not as a limitation.

What is claimed is:

1. A resource based method for evaluating the business performance of a business enterprise, said method comprising the following steps:
allotting weightages to the financial resources of the enterprise consisting of money, material, energy and machines, manpower, management and information, said weightages being further segregated into cost based measures and value based measures, each of these weightages for each of the financial resources ranging in a scale from 3 to 12.5 for cost based measures and from a range of 2.75 to 10.75 for value based measures;
extracting the monetary price from the cost side of the financial report of the enterprise for each of the financial resources in terms of cost, utilization and performance;
computing the total score (A) of said cost based measures which is a summation of the individual scores computed for each of said financial resources based on pre-determined functions using said extracted monetary price, said score being a score in the range of 0 to 400 resource tool profit points;
extracting the monetary value from the sale side of the financial report for each of the financial resources in terms of cost, utilization and performance;
computing the total score (B) of said value based measures which is a summation of the individual scores computed for each of said financial resources based on pre-determined function using said extracted monetary value, said score being the score in the range of 0 to 600 resource tool profit points;
providing a score card for a set of non-financial resources consisting of customer focusing, quality of products and services, employee satisfaction, ability to formulate appropriate business strategies, each of these parameters defined by a set of questions to be responded by designated personnel of said enterprise;
assigning weightages to each of said non-financial resources;
examining the responses elucidated;
computing the score (C) based on said responses and weightages to obtain a score in the scale of 0 to 500 resource tool profit points;
summing the scores of A+B+C to obtain the overall resource based performance of said business enterprise; and
grading the performance from a scale of 0-1500 resource tool profit points in a pre-determined manner.

2. A method as claimed in claim 1, wherein the step of computing the score for the financial resource ‘money’ based on predetermined function using said extracted monetary price includes the following steps:
a) determining a first numerical value by subtracting the value of the risk free rate for money from the numerical value 1 and dividing it by the weighted average cost of capital for money, said first numerical value being multiplied by 5 and further multiplied by a weightage allotted for the sector in which the business enterprise is conducting business;
b) determining a second numerical value by subtracting the value of Capital Employed for money from the numerical value 1 and dividing it by the Cost of Sales for money, said second numerical value being multiplied by 5 and further multiplied by a weightage allotted for the sector in which the business enterprise is conducting business; and
c) summing the first numerical value and the second numerical value.

3. A method as claimed in claim 1, wherein the step of computing the score for the financial resource ‘Material/Energy’ based on predetermined function using said extracted monetary price includes the following steps:
a) determining a third numerical value by subtracting the value of the Material and Energy cost for ‘Material/Energy’ from the numerical value 1 and dividing it by the cost of sales for ‘Material/Energy’, said third numerical value being multiplied by 4 and further multiplied by a weightage allotted for the sector in which the business enterprise is conducting business;
b) determining a fourth numerical value by subtracting the value of Inventory for ‘Material/Energy’ from the numerical value 1 and dividing it by the Cost of Sales for ‘Material/Energy’, said fourth numerical value being multiplied by 6 and further multiplied by a weightage allotted for the sector in which the business enterprise is conducting business; and
c) summing the third numerical value and the fourth numerical value.

4. A method as claimed in claim 1, wherein the step of computing the score for the financial resource ‘Machine’ based on predetermined function using said extracted monetary price includes the following steps:
a) determining a fifth numerical value by subtracting the value of depreciation of the ‘Machines’ from the numerical value 1 and dividing it by the cost of sales for ‘Machines’, said fifth numerical value being multiplied by 5 and further multiplied by a weightage allotted for the sector in which the business enterprise is conducting business;
b) determining a sixth numerical value by subtracting the written down value for ‘Machines’ from the numerical value 1 and dividing it by the Cost of Sales for the ‘Machine’, said sixth numerical value being multiplied by 5 and further multiplied by a weightage allotted for the sector in which the business enterprise is conducting business; and
c) summing the fifth numerical value and the sixth numerical value.

5. A method as claimed in claim 1, wherein the step of computing the score for the financial resource ‘Manpower’ based on predetermined function using said extracted monetary price includes the following steps:
a) determining a seventh numerical value by subtracting the value of direct manpower cost for ‘Manpower’ from the numerical value 1 and dividing it by the cost of sales for ‘Manpower’, said seventh numerical value being multiplied by 5 and further multiplied by a weightage allotted for the sector in which the business enterprise is conducting business;
b) determining an eighth numerical value by dividing company average costs of sales by direct employee for ‘Manpower’ and a ninth numerical value obtained by multiplying the industrial average cost of sales by 2 and further dividing the ninth numerical value by the direct employee for ‘Manpower’;
c) determining a tenth numerical value obtained by division of the eighth numerical value by the ninth numerical value, said tenth numerical value being multiplied by 5 and further multiplied by a weightage allotted for the sector in which the business enterprise is conducting business; and
d) summing the seventh numerical value and the tenth numerical value.

6. A method as claimed in claim 1, wherein the step of computing the score for the financial resource ‘Management’ based on predetermined function using said extracted monetary price includes the following steps:
a) determining a eleventh numerical value by subtracting the value of indirect manpower for ‘Management’ from the numerical value 1 and dividing it by the cost of sales for ‘Management’, said eleventh numerical value being multiplied by 5 and further multiplied by a weightage allotted for the sector in which the business enterprise is conducting business;
b) determining a twelfth numerical value by dividing company average costs of sales by indirect employee for ‘Management’ and a thirteenth numerical value obtained by multiplying the industrial average cost of sales by 2 and further dividing the thirteenth numerical value by the indirect employee for ‘Management’;
c) determining a fourteenth numerical value obtained by division of the twelfth numerical value by the thirteenth numerical value, said fourteenth numerical value being multiplied by 5 and further multiplied by a weightage allotted for the sector in which the business enterprise is conducting business; and
d) summing the eleventh numerical value and the fourteenth numerical value.

7. A method as claimed in claim 1, wherein the step of computing the score for the financial resource ‘Information’ based on predetermined function using said extracted monetary price includes the step of determining a fifteenth numerical value by subtracting the value of information technology cost for ‘Information’ from the numerical value 1 and dividing it by the cost of sales for ‘Information’, said fifteenth numerical value being multiplied by 10 and further multiplied by a weightage allotted for the sector in which the business enterprise is conducting business.

8. A method as claimed in claim 1, wherein the step of computing the score for the financial resource ‘money’ based on predetermined function using said extracted monetary value includes the following steps:
a) determining a sixteenth numerical value by dividing the economic value addition by the Capital Employed for money by the companies;
b) determining a seventeenth numerical value by dividing the economic value addition by the Capital Employed for money by the industries, the seventeenth numerical is further multiplied by 2;
c) determining a eighteenth numerical value by dividing said sixteenth numerical value by the seventeenth numerical value, said eighteenth numerical value being multiplied by 5 and further multiplied by a weightage allotted for the sector in which the business enterprise is conducting business;
d) determining a nineteenth numerical value by subtracting the value of Capital Employed for money from the numerical value 1 and dividing it by the Cost of Sales for money, said nineteenth numerical value being multiplied by 5 and further multiplied by a weightage allotted for the sector in which the business enterprise is conducting business; and
e) summing the eighteenth numerical value and the nineteenth numerical value.

9. A method as claimed in claim 1, wherein the step of computing the score for the financial resource ‘Material/Energy’ based on predetermined function using said extracted monetary value includes the following steps:
a) determining a twentieth numerical value by adding the expenses to the value of the Material and Energy cost for ‘Material/Energy’ and further subtracting said determined twentieth numerical value from the numerical value 1, and still further dividing said twentieth numerical value by the value of sales for ‘Material/Energy’, said twentieth numerical value being multiplied by 5 and further multiplied by a weightage allotted for the sector in which the business enterprise is conducting business;
b) determining a twenty-first numerical value by subtracting the value of Inventory for ‘Material/Energy’ from the numerical value 1 and dividing it by the value of Sales for ‘Material/Energy’, said twenty-first numerical value being multiplied by 5 and further multiplied by a weightage allotted for the sector in which the business enterprise is conducting business; and
c) summing the twentieth numerical value and the twenty-first numerical value.

10. A method as claimed in claim 1, wherein the step of computing the score for the financial resource ‘Machine’ based on predetermined function using said extracted monetary value includes the following steps:
a) determining a twenty-second numerical value by subtracting the value of depreciation of the ‘Machines’ from the numerical value 1 and dividing it by the value of sales for ‘Machines’, said twenty-second numerical value being multiplied by 5 and further multiplied by a weightage allotted for the sector in which the business enterprise is conducting business;
b) determining a twenty-third numerical value by subtracting the written down value for ‘Machines’ from the numerical value 1 and dividing it by the value of Sales for the ‘Machine’, said twenty-third numerical value being multiplied by 5 and further multiplied by a weightage allotted for the sector in which the business enterprise is conducting business; and
c) summing the twenty-second numerical value and the twenty-third numerical value.

11. A method as claimed in claim 1, wherein the step of computing the score for the financial resource ‘Manpower’ based on predetermined function using said extracted monetary value includes the following steps:
a) determining a twenty-fourth numerical value by subtracting the value of direct manpower cost for ‘Manpower’ from the numerical value 1 and dividing it by the value of sales for ‘Manpower’, said twenty-fourth numerical value being multiplied by 5 and further multiplied by a weightage allotted for the sector in which the business enterprise is conducting business;
b) determining an twenty-fifth numerical value by dividing company average costs of sales by direct employee for ‘Manpower’ and a twenty-sixth numerical value obtained by multiplying the industry average cost of sales by 2 and further dividing the twenty-sixth numerical value by the direct employee for ‘Manpower’;
c) determining a twenty-seventh numerical value obtained by division of the twenty-fifth numerical value by the twenty-sixth numerical value, said twenty-seventh numerical value being multiplied by 5 and further multiplied by a weightage allotted for the sector in which the business enterprise is conducting business; and
d) summing the twenty-fourth numerical value and the twenty-seventh numerical value.

12. A method as claimed in claim 1, wherein the step of computing the score for the financial resource ‘Management’ based on predetermined function using said extracted monetary value includes the following steps:
a) determining a twenty-eighth numerical value by subtracting the value of indirect manpower for ‘Management’ from the numerical value 1 and dividing it by the value of sales for ‘Management’, said twenty-eighth numerical value being multiplied by 5 and further multiplied by a weightage allotted for the sector in which the business enterprise is conducting business;
b) determining a twenty-ninth numerical value by dividing company average costs of sales by indirect employee for ‘Management’ and a thirtieth numerical value obtained by multiplying the industry average cost of sales by 2 and further dividing the thirtieth numerical value by the indirect employee for ‘Management’;
c) determining a thirty-first numerical value obtained by division of the twenty-ninth numerical value by the thirtieth numerical value, said thirty-first numerical value being multiplied by 5 and further multiplied by a weightage allotted for the sector in which the business enterprise is conducting business; and
d) summing the twenty-eighth numerical value and the thirty-first numerical value.

13. A method as claimed in claim 1, wherein the step of computing the score for the financial resource ‘Information’ based on predetermined function using said extracted monetary value includes the step of determining a thirty-second numerical value by subtracting the value of information technology cost for ‘Information’ from the numerical value 1 and dividing it by the value of sales for ‘Information’, said thirty-second numerical value being multiplied by 10 and further multiplied by a weightage allotted for the sector in which the business enterprise is conducting business.

14. A method for evaluating the business performance of a business enterprise as claimed in claim 1, in which any one of the weightages are editable to adapt to dynamic real life situations.

15. An apparatus for evaluating the business performance of a business enterprise, said apparatus comprising:
a user interface adapted to receive the credentials of a business enterprise and its financial reporting data and feedback in the forms of questionnaires from the stakeholders of the business enterprise;
extraction means to extract the monetary price from the cost side of the financial reports, the monetary value from the sales side of the financial reports and the responses to the questionnaires provided by the stakeholders;
cost measure means (A) co-operating with the extraction means and adapted to evaluate the cost based measure of financial resources including money, material, energy and machines, manpower, management and information, in terms of cost, utilization and performance from the cost side of the financial reports from a scale of 0-400 resource tool profit points based on pre-determined functions;
value measure means (B) co-operating with the extraction means to evaluate the value based measure of financial resources in terms of value, utilization and performance from the sales side of the financial reports from a scale of 0-600 resource tool profit points based on pre-determined functions;
non-financial measure means (C) adapted to evaluate the performance of the business enterprise based on non-financial resources from a scale of 0-500 resource tool profit points based on a set of questionnaires;
summing means to add the scores received from A+B+C; and
grading means to grade the performance from a scale of 0-1500 resource tool profit points in a pre-determined manner.

16. An apparatus as claimed in claim 15, wherein said cost measure means is further adapted to assign weightages to each of financial resources ranging in a scale from 3 to 12.5.

17. An apparatus as claimed in claim 15, wherein said value measure means is further adapted to assign weightages to each of financial resources ranging in a scale from 2.75 to 10.75.
